(19) United States
(12) Patent Application Publication
(10) Pub. No.: US 2017/0246630 A1
(43) Pub. Date: Aug. 31, 2017

(54) ENHANCED ENVIRONMENTAL CONTROL RESERVOIR APPARATUS AND METHOD OF USE

(71) Applicant: Click Bio, Inc., Reno, NV (US)

(72) Inventors: Mykle Gaynor, Sparks, NV (US); Craig Vincze, Reno, NV (US); Justin Ferranto, Reno, NV (US)

(73) Assignee: Click Bio, Inc., Reno, NV (US)

(21) Appl. No.: 15/445,899

(22) Filed: Feb. 28, 2017

Related U.S. Application Data
(60) Provisional application No. 62/301,122, filed on Feb. 29, 2016.

(51) Int. Cl. B01L 3/00

(52) U.S. Cl. CPC B01L 3/50851; B01L 2300/0829; B01L 2300/0858; B01L 2300/0848; B01L 2300/18

(57) ABSTRACT

Methods, systems, and devices are described for fabricating and using an ANSI-SLAS compatible environmental control reservoir apparatus having one or more thermally conductive and/or magnetic aspects. In one embodiment, the apparatus may comprise a well plate containing a plurality of wells enabled to hold liquid, wherein the well plate is configured to geometrically mate with an adapter. The surface area of each well may be controlled by the addition of fins extending inwardly towards the axial center of each well volume. In some embodiments, the adapter provides a plurality of magnetized rods to which a magnetic field may be applied to enable thermal control of the well plate and associated liquid.

### CROSS-REFERENCE TO RELATED APPLICATIONS

This application claims priority to, and incorporates by reference, the applicants' prior provisional patent application, titled Improved Thermally Conductive Container, Ser. No. 62/301,122 filed Feb. 29, 2016.

### FIELD OF THE DISCLOSURE

The present disclosure relates to thermally conductive reagent troughs, associated heating elements, and their methods of use, and in aspect to thermally conductive SBS reagent troughs, associated heating elements, and their methods of use

### BACKGROUND OF SOME ASPECTS OF THE DISCLOSURE

Existing microplate technology is used as a standard tool for analytical research and clinical diagnostic testing laboratories. A microplate (also known as a microwell plate, well plate, and/or a microtiter plate) may be a Society for Biomolecular Sciences (SBS) compliant trough or plate with multiple wells to be used as test tubes or containers for liquid. See applicants' co-pending non-provisional patent application, titled “Reservoir Assembly and Method of Use,” Ser. No. 15/188,697, filed Jun. 21, 2016, USPTO Publication No. US-2017-0028400, which is incorporated by reference herein (except that, in the event of any inconsistency between that application and this specification, this specification shall prevail). A typical such microplate can have any number of wells (e.g., 6, 24, 96, 384, or 1536) arranged in a 2:3 rectangular matrix, with each well of a microplate providing a generally tubular or box-shaped laterally extending interior for holding anywhere between tens of nanolitres to several milliliters of liquid.

Some prior art laboratory applications require temperature control of liquids located in the wells of microplates and/or may require ramping up a chilled plate to room temperature or another desired temperature. In order to control the temperature of the microplate, and thus the liquid in the wells, adapters or other structures have been used to mate a heating and/or cooling element to a microplate. The microplate and the adapters are commonly made by different companies and thus each microplate and adapter combination often do not mate correctly, sufficiently, or more efficiently in view of the desire energy transfer and temperature control.

In other applications, laboratory operators have selected a microplate that suits the user's research needs and then had a specific heating and/or cooling adapter custom-made to mate with the underside of the selected plate more closely. Alternatively, some users have selected the heating and/or cooling element/adapter first, and then selected a microplate that most closely aligns with the selected element. Typically, no pre-existing heating and/or cooling device mates sufficiently with pre-existing microplates, and researchers are forced to settle for the closest microplate/adapter match available, or required to have custom heating elements made, as opposed to selecting the equipment which is best suited for the user's needs.

In addition, prior art microplates typically have space around the perimeter wells differing from the space between the interior wells, causing external devices to have a different geometry from the perimeter wells. If magnetic posts are used in conjunction with these microplates, the result may be different magnetic fields in the perimeter wells than the magnetic fields in the interior wells.

Prior art microplates can, in some embodiments, consist of a frame made from a polymer selected to withstand thermal cycling for applications such as polymerase chain reactions (PCR). In these embodiments, however, the frames are typically used only for applications where the well volumes are very small (e.g., less than 500 microlitres).

### BRIEF SUMMARY OF SOME ASPECTS OF THE DISCLOSURE

The applicants believe they have discovered at least some of the problems and issues with the prior art noted above. They have therefore invented a reservoir or container having a well plate with fins or other well surface expanding or modifying structure, and in some embodiments, an associated thermal or other environmental control device having, in some embodiments, one or more vertical posts or elements whose periphery mates with, is exposed to, adjacent to, or faces, or connects to one or more aspects of the geometry of the underside of the well plate to provide a pre-determined fit or orientation of the posts or elements with respect to the well plate or one or more portions of a well plate.

In some embodiments the well plate includes one or more wells having one or more fins or other structure expanding the amount of contact or exposure between the interior of the well and, for example, material such as fluid placed within the well. In some applications, the fins or other such structure can increase the thermally conductive surface area of the well, thus increasing the ability to modulate or control the temperature of the well, the corresponding well plate, and any liquid or substance contained within the well. In some instances, the fin or other structure may be magnetic or magnetizable in whole or in part.

In some embodiments, the fins or other contact or exposure expanding structure may extend from one or more well side walls inwardly into the interior of the well. The fins of other such structure may have any of a wide variety of shapes, such rectangular or having variously sloped sides. The fins or other such structure may extend any desired length along of from, for example, the lateral length of well or side wall of a well.

In some embodiments, the fins and associated well structure may provide retention walls or spaces for retaining components that may be utilized within a well, such as heatable, reactive, of other types of beads, pellets, or other components for example.

In some embodiments, an environmental control device or adapter may provide structure adapted to mate with, face or be exposed to, or abut a portion of one or more wells or other structure in a well plate. Some applications can provide a an adapter base having a plurality of posts—in some embodiments heat transfer or control posts—in, associated with, or extending from the base and being penetrable into post channels penetrating an associated well plate. In some instances, the one or more post channels abut at least a portion of the well structure, such as an adjacent fin or other heat transfer structure. Some embodiments provide a post channel abutting or sufficiently adjacent to one or more fins or other heat transfer structures so that a mating heat transfer arm may similarly abut or be sufficiently adjacent to the one or more fins or other environmental control structures extending from or penetrating a well side, bottom, or edge surface

Some instances provide a one piece well plate with a one or more wells and/or more associated fins or other well-surface expanding or environmental control structure formed within the one piece well plate. Similarly, some instances of the heating or other environmental control device or adapter provide a one-piece device with one or more environmental control structure, in some cases posts, formed within, an being an integral part of, the one-piece device.

In some embodiments, the fins, other heat transfer or well surface expanding structures, and/or the well plate are made in whole or in part from material that more readily transfers or controls heat transfer, can provide a magnetic field, and/or lasts longer in providing or supporting any of such functions. In some embodiments, an associated adapter includes one or more of such materials, such as in or on one or more posts on the adapter.

Novel methods of use of a well plate and/or associated adapters—in some instances heating adapters or devices—are disclosed. Some embodiments provide mounting of a well plate, with expanded well surfaces, such as one or more fins or other structure extending from or into a well side wall, to a heating or other environmental control device having a base with one or more posts or other structure extending from or connected to the base to abut a mating exterior well structure. The methods may variously utilize the variously described alternative or additional structures explained above.

This disclosure provides a novel system and method of fabrication and use of a thermally conductive or other environmental control well plate, including an SBS compliant well plate, and/or an associated environment control device—in some cases, a heating or heat transfer control device. There are many other novel features and aspects of this disclosure. They will become apparent as this specification proceeds. It is to be understood, however, that the scope of a claim in this matter is to be determined by the claim as issued and not by whether the claim addresses an issue, or provides a feature, because the issue or feature is referenced in the Background or Brief Summary sections above.

### BRIEF DESCRIPTION OF THE DRAWINGS

The applicants' preferred and other embodiments are described in association with the accompanying Figures in which:

FIG. 1 is an isometric view of a wholly or partially thermally conductive well (and optionally or alternatively magnetic or magnetizable) well plate;

FIG. 2 is an exploded isometric view of the well plate of FIG. 1 above an associated and mating heating device or adapter;

FIG. 3 is a top plan view of the well plate of FIG. 1;

FIG. 4A is an elevational view of the thermally conductive well plate of FIG. 1;

FIG. 4B is a cross-sectional view taken along the section line 4B-4B of FIG. 4A;

FIG. 4C is a side elevational view of the heating device of FIG. 2;

FIG. 4D is a cross-sectional view taken along the section line 4D-4D of FIG. 4C;

FIG. 5 is a cross-sectional view taken along the section line 5-5 of FIG. 4A;

FIG. 6 is a bottom view of a thermally conductive well plate;

FIG. 7 is a cross-sectional view taken along the section line 7-7 of FIG. 3;

FIG. 8 is an isometric view of an alternative embodiment of a wholly or partially thermally conductive (or optionally or alternatively magnetic or magnetizable) well plate;

FIG. 9 is an elevational view of the well plate of FIG. 8;

FIG. 10 is an elevational view of the well plate of FIG. 8;

FIG. 11 is a cross-sectional view taken along the section line 8-8 of FIG. 8; and

FIG. 12 is a top plan view of the well plate of FIG. 8.

### DETAILED DESCRIPTION

The prior Brief Summary and the following Detailed Description provide examples that are not limiting of the scope of this specification. One skilled in the art would recognize that changes can be made in the function and arrangement of elements discussed without departing from the spirit and scope of the disclosure. Various embodiments can omit, substitute, add, or mix and match various procedures or components as desired. For instance, the methods disclosed can be performed in an order different from that described, and various steps can be added, omitted, or combined. Also, features disclosed with respect to certain embodiments can be combined in or with other embodiments as well as features of other embodiments.

The reservoir apparatus and methods of use described in this Detailed Description can be compliant with the standard for lab automation under the American National Standards Institute (ANSI)—Society for Laboratory Automation and Screening (SLAS) (previously known as the ANSI-SBS). The standard for well plates (or microplates) under the ANSI-SLAS is a standard footprint of microplates having x-y dimensions arranged in a 2:3 rectangular matrix. The well plates, along with the associated adapters, described in this section can be compliant with the ANSI-SLAS standard.

In one embodiment, a described well plate has a plurality of well sections arranged in columns and rows. The underside of the well plate contains a plurality of post cavities disposed between the well sections, so that the well plate may be lowered over, or otherwise mounted to, an adapter base having a plurality of vertical posts extending from the base. The exterior geometry of the vertical or laterally extending posts matches the interior geometry of the cavities such that when the well plate is lowered over, or mounted to, the adapter base, the exterior of each vertical post abuts a mating interior of an associated cavity. In some embodiments, the t exterior post geometry is designed to be at least a partial inverse of an associated post cavity interior geometry so that the well plate rests on the posts when the well plate is lowered over the adapter. Protruding inwardly into each well from the well walls are one or more fins, protrusions, or baffles. The addition of the fins, protrusions, or baffles to the inside of the wells increases the surface area of the wells, which aids in accelerating heat transfer, and control of heat transfer, between the wells and material such as liquid within a well.

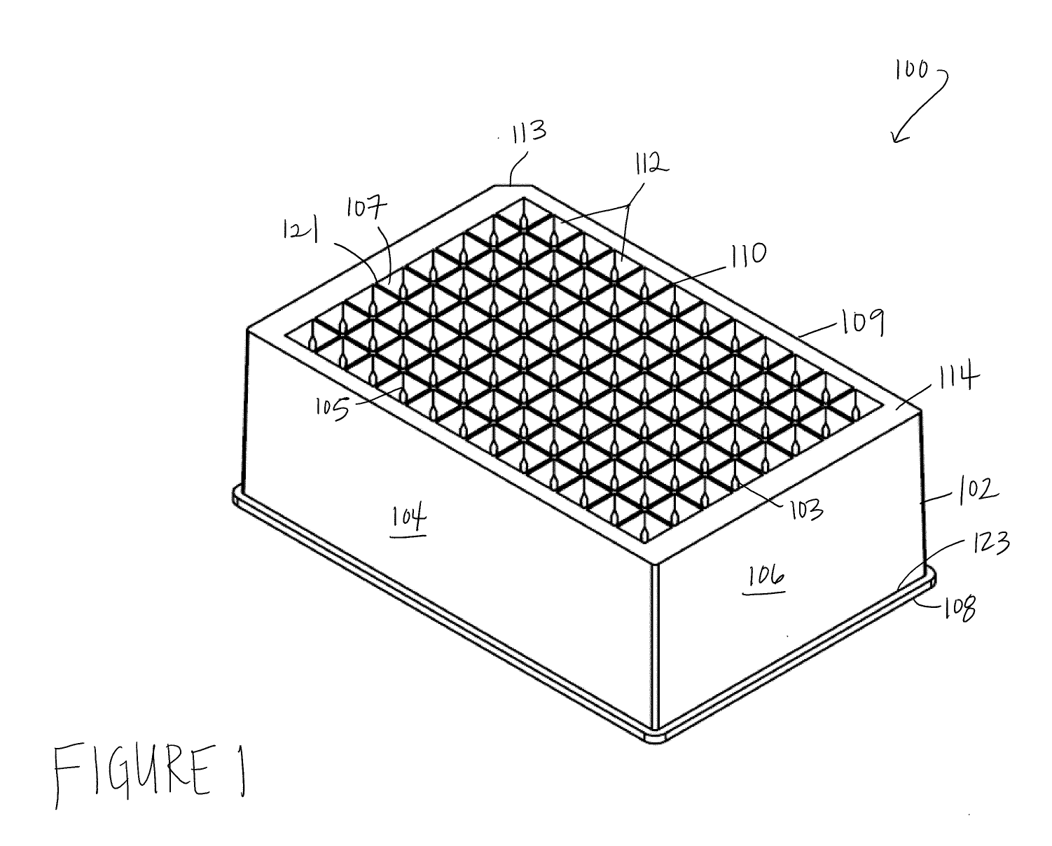

Referring now to FIG. 1, an example thermally conductive container 100 has a well plate 102 mounted to an associated adapter (not shown in FIG. 1). The well plate 102 (also known as a multi-well plate, a microplate, and/or a microtiter plate), is a liquid container or trough for automated liquid handling equipment used in the laboratory automation industry. In FIG. 1, an exemplary 96-well plate 102 by is shown; however, any size well plate may be provided, such as 6-, 24-, 96-, 384-, or 1536-well plates, for example.

Well plate 102 provides a rectangular configuration of eight (8) rows, e.g, 103, by twelve (12) columns, e.g., 105, of wells, e.g., 107, separated by a plurality of common walls, e.g., 110, yielding a row-to-column ratio of 2:3. Well plate 102 has two opposed short planar sides 104, 109 extending perpendicularly between two opposed long planar sides 106, cooperatively forming a rectangular housing 111 surrounding the wells, e.g., 107, within the housing 111. The housing 111 also has (i) a generally flat, rectangular top edge 114 co-planar with the upper edges, e.g., 121, of the wells, e.g., 107, opposite (ii) a rectangular lower edge 108 extending outwardly from the bottom 123 of the housing 111.

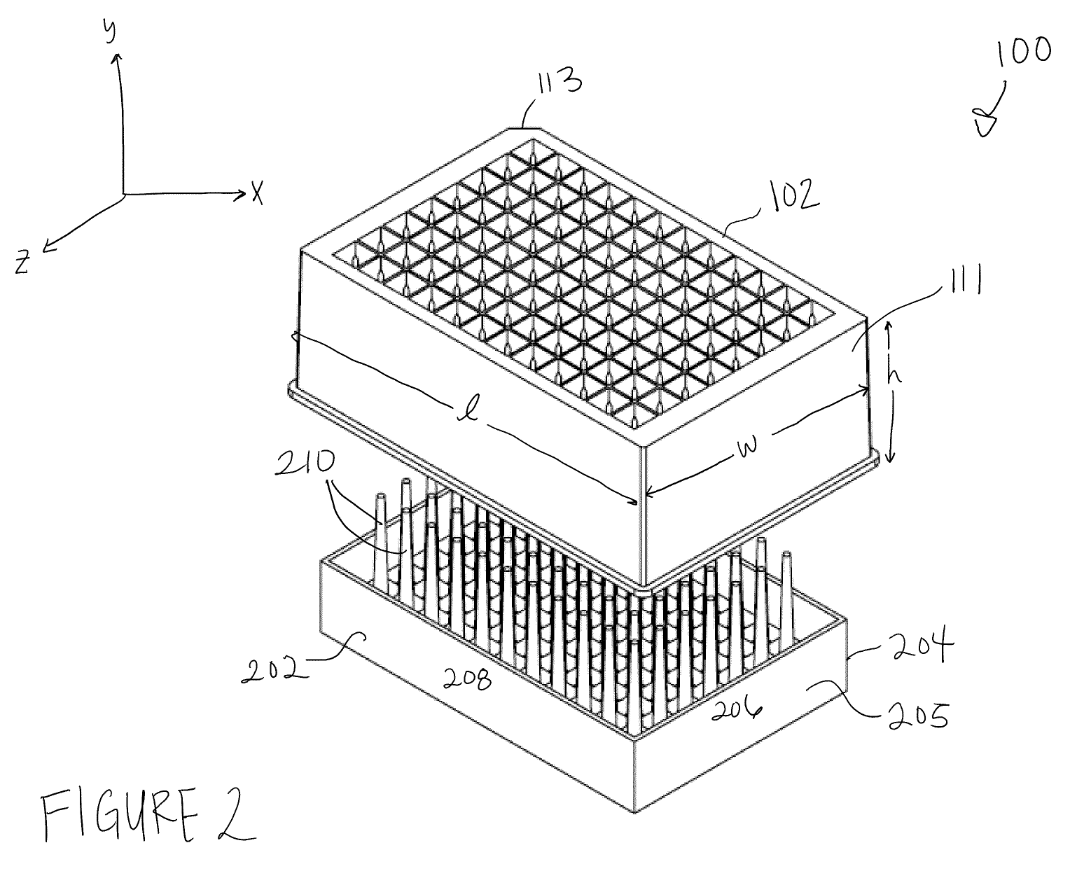

With reference now to FIG. 2, the well plate 102 may have a beveled alignment corner 113 extending downwardly to the bottom 123 of the housing 111. The beveled alignment corner 113 may mate with a matingly beveled corner (not shown) in the associated adapter 202 in order ensure proper mating alignment of the housing 111 with the adapter 202. Other mating alignment structures may be used in addition to, or instead of, a beveled alignment corner.

Well plate 102 may be made from a biocompatible material that will not leach or release particles into the wells that could interfere with the experiment. In some embodiments, the well plate 102 may be comprised partially or entirely of a plastic material. Is some embodiments, the plastic is a thermally conductive material that facilitates faster temperature control of the liquids contained within the well. Plastics that may be used for the well plate 102 may include polypropylene, polystyrene, polycarbonate, or any suitable polymer or composite engineered to facilitate thermal control.

In some embodiments, each or any component of the well plate 102 may be made from a plastic material and affixed together using means known in the art, such as by use of epoxy, for example. In other embodiments, the components of the well plate 102 may be molded as many separate pieces or as a single piece. In still other embodiments, the components of the well plate 102 may be extruded or printed as many separate pieces then assembled together or as a single, unitary piece.

The upper edges of the wells 112 may provide a square grid, with the upper edge of each well being a square shape. Although, the wells in FIG. 1 are shown as having an upper-edge square configuration, the upper-edge of the wells 112 may be any suitable shape, including oval, circular, triangular, rectangular, etc. The shape of the wells 112 may vary from the upper-edge of the well down through the bottom of the well at the bottom 123 of the well plate 111. With reference now to FIG. 2, the well plate 102 may have a length l, width w, and height h. In one example, the length l may be approximately 128 mm, the width w may be approximately 86 mm, and the height h may be approximately 20 mm; however, the measurements described are examples and well plate 102 may be of any desired or suitable dimensions, particularly when complying with standards such as explained above.

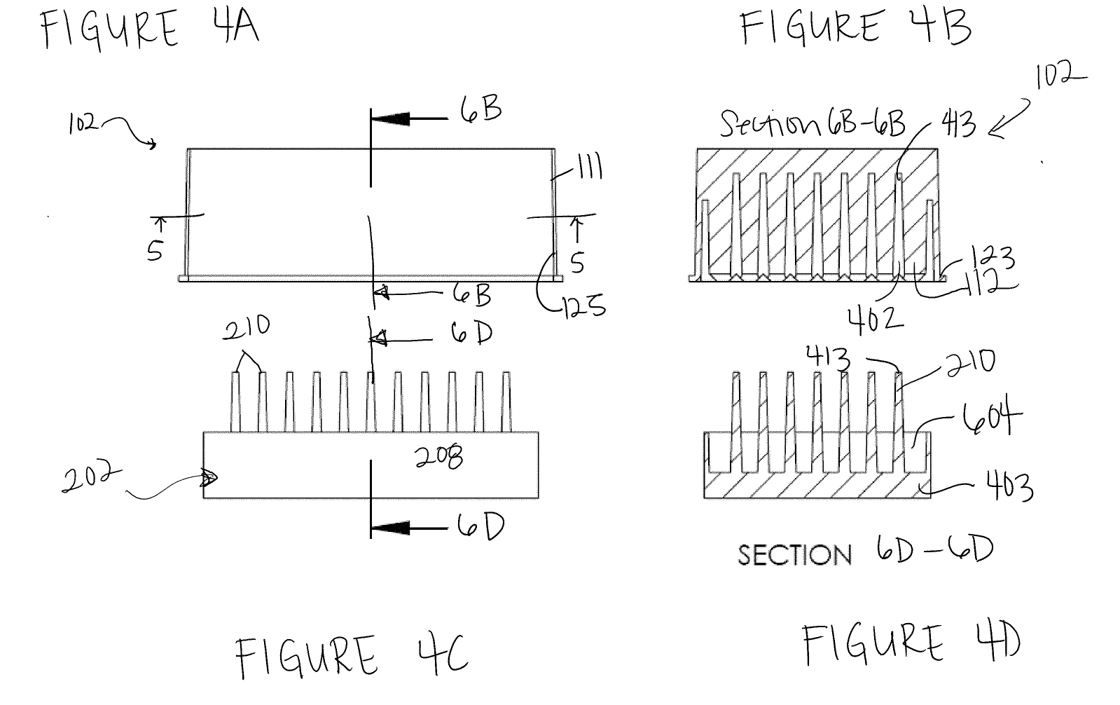

Adapter 202 provides a rectangular outside base housing 204 having two opposed, planar long walls 208 extending perpendicularly between two opposed, planar shorter walls 206. The dimensions of adapter 202 are such that the outer periphery 205 of the base housing 204 is slightly smaller and fits abuttingly within the inner periphery 125 (not shown in FIG. 2 but see FIG. 4A) of the well plate housing 111.

Well plate penetrating posts, e.g., 210, extend upwardly and, in some cases, outwardly from the rectangular adapter base housing 204. The well plate 102 may be made of a plastic material, the posts 112 and the adapter 102 may be made of a readily heatable or coolable metal material, such as aluminum, for example. In one embodiment, the posts 210 may be made of magnetizable material (such as a metal including sufficient iron) and magnetized, in some embodiments, so that the resulting magnetic fields are of equal strength and spaced equally along the long axis (e.g., y-axis in FIG. 2) of a post, e.g., 210. The metal, and optionally magnetizable, material of the posts 210 can be heated and cooled in ways well known in the art to provide thermal control of the well plate 102 and the liquid in wells 112.

In one embodiment, the adapter 202 and the included posts 210 may be molded or otherwise formed to provide a single piece, unitary adapter 202, or each or any components of the adapter 202 and posts 210 may be molded as separate pieces and affixed together with, for example, an epoxy or other affixation technique. In other embodiments, the adapter 202 and the posts 210 may be extruded or printed as a single piece or as multiple pieces affixed together

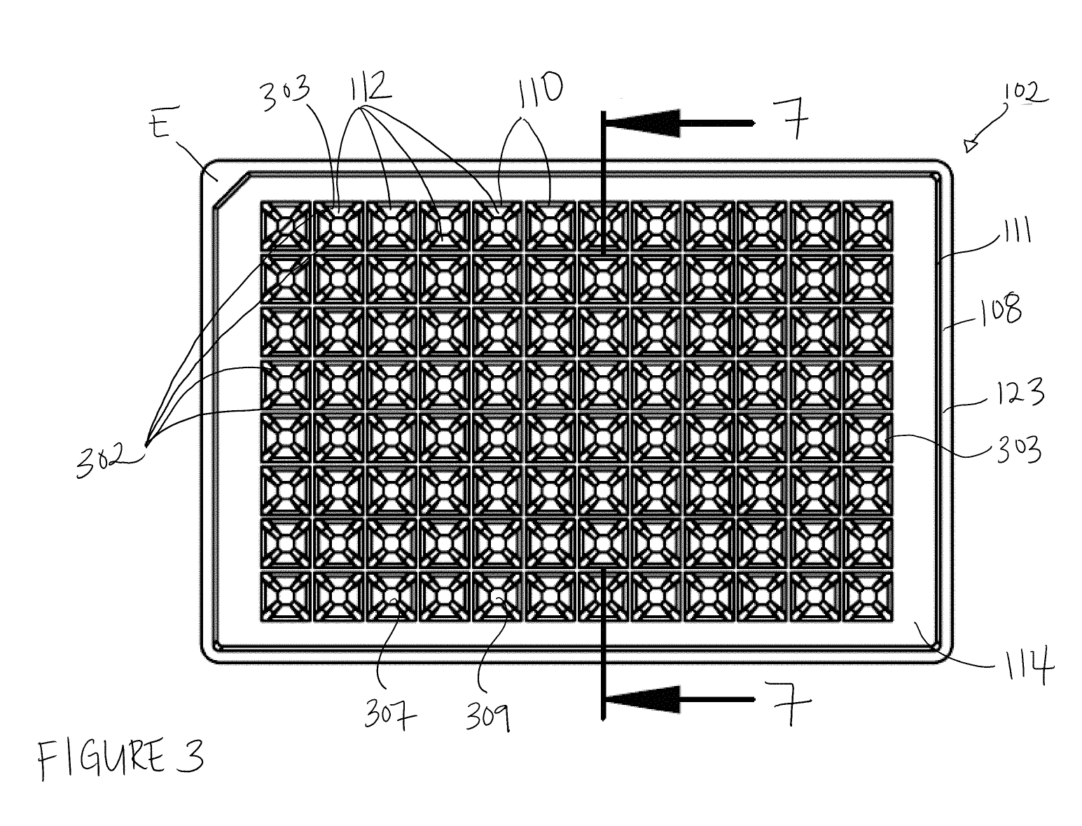

With reference now to FIG. 3, the wells, e.g., 112, may be formed and separated from each other by common walls, e.g., 110. The walls, e.g., 110 may provide a square cross-section at the upper-edge of each well, e.g., 112, and the walls, e.g., 110, may taper inward or may flare outward as the walls extend towards the bottom 123 of the housing 111 of the well plate 102. In other embodiments, the walls, e.g., 110, do not taper towards the bottom 123 of the well plate 102 or its housing 123.

Extending inwardly from the inside periphery, e.g., 303, of well walls, e.g., 110, of each well, e.g., 112, are a plurality of inwardly protruding baffles, protrusions, or fins 302. In the embodiment of FIG. 3, a fin, e.g., 302 extending inwardly within the well, e.g., 112, from each of the four corners of the well, e.g., 112.

The fins, e.g., 302, may be affixed to the inside of walls 110 and extend inward toward the axial center, e.g., 307, the well, e.g., 112, or the fins, e.g., 302, may be formed, such as by molding, printing, or extrusion, as an integral part of the well, e.g., 112, and well plate 102. As with the well plate 102 as a whole, the fins 302 may be made of a plastic material or other material providing desired heat transfer or magnetic properties. The fins, e.g., 302, may be the same plastic or other material of the remainder of the well plate 102, or the fins, e.g., 302, may be made of a different plastic or other materials.

The fins, e.g., 302, are shown as being of equal length and symmetrically disposed within the well, e.g., 302; however, the fins, e.g., may be symmetric, asymmetric, of varying length, widths, and/or shapes. Regardless of their number and placement, the fins, 302, expand the surface area of the material (not shown) within the well, e.g., 112 while providing enough space in the well, e.g., 112, such as its central area, e.g., 309, for insertion of, for example, a pipette tip into the well, e.g., 112, to add or remove material, such as a liquid for example (not shown) within the well, e.g., 112.

In some embodiments, one or more such fins (or other well varying structure, inwardly or outwardly from the general periphery of the well) within one or more, or all, of the wells in well plate can therefore increase the surface area of the interior well surface (and the well plate 102 as a whole) so that the temperature of the liquid in the wells can be modulated and controlled more quickly and efficiently than wells not including one or more such structure(s).

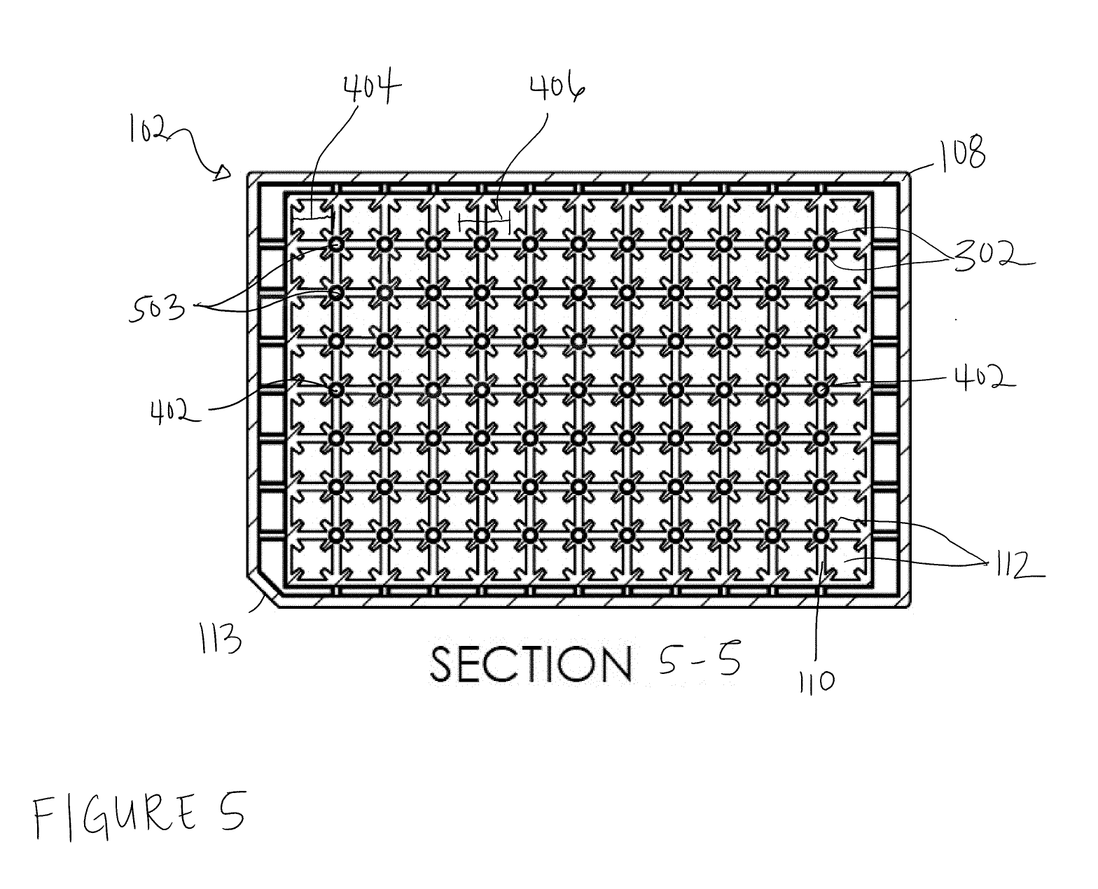

With reference now to FIGS. 4A, 4B, and 5, post penetrating passages or cavities, e.g, 402, extend within the well plate 102 transversely upwardly from the bottom 123 of the well plate housing 111. Turning now to FIGS. 4C and 4D, tapered, frusto-conical adapter posts, e.g., 402, extend transversely upwardly from the adapter base 403 in the adapter 202 to thereby penetrate fully within and abut, as shown in FIGS. 4A, 4B, and 5, the matingly configured post penetrating cavities, e.g., 402, in the well plate 102.

The embodiment of FIGS. 4 B and 4D shows the bottom surface, e.g., 409, of each well, e.g., 411, as flat and transverse to the upwardly extending adjacent sides, e.g., 413, of the well, e.g., 411. The well bottom may have other configurations as desired, such as rounded, pyramidal, inverse pyramidal, etc. In the embodiment of FIG. 4B through FIG. 4D, the posts, e.g., 210 are conical and thus the circumference of each post is larger where the post, e.g., 210, couples to the adapter base 403 of the adapter 202 and tapers to a smaller circumference at the distal end 413 of the post, e.g., 210. In other embodiments of one or more posts (not shown), the posts may be cylindrical and thus may be the same circumference from the proximate to the distal end of each post. In yet other embodiments (not shown), the cross-section of one or more posts may be square, rectangular, diamond-shaped, triangular, or any other shape for which the cross-sectional geometry of the posts mates with the cross-sectional geometry of the cavities 402 of the well plate 102. Further, yet other structures may be used to provide sufficient contact, such as heat transfer contact as desired, between an adapter and associated well or well plate.

In addition, depending on the configuration of the well plate 210 (e.g., how many wells and how the wells are structured), the orientation and configuration of the posts 210 or other structure in contact with, or adjacent, an associated well plate, cavity(ies), etc. may vary. In some embodiments, the posts may be evenly spaced to mate into the cavities 402. Alternatively, other configurations may be provided, such as posts that mate with alternating cavities, outer cavities, inner cavities, etc.

In some embodiments, one or more of the posts, e.g., 210, include a magnetic material and may be affixed to the base by welding, adhesive, or other coupling material or structure. In another embodiment, the adapter 202 may be a one piece structure and formed, for example, by molding, extrusion, or 3D printing (“printing”).

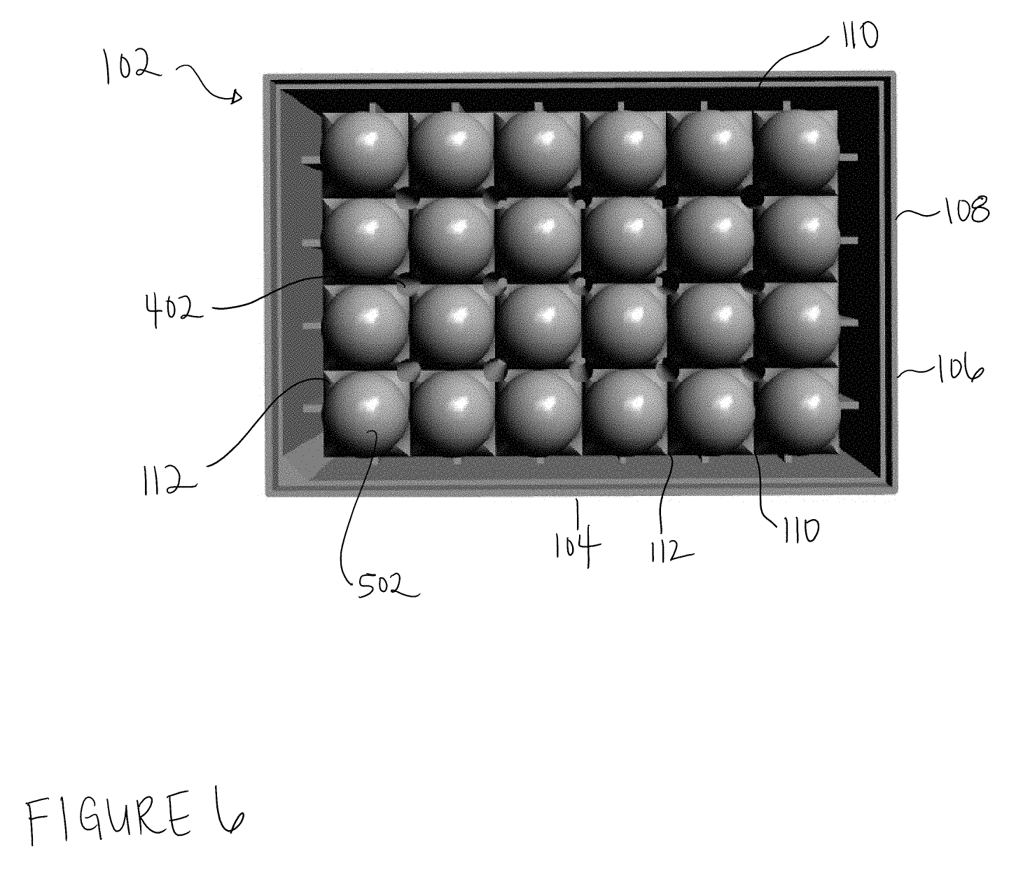

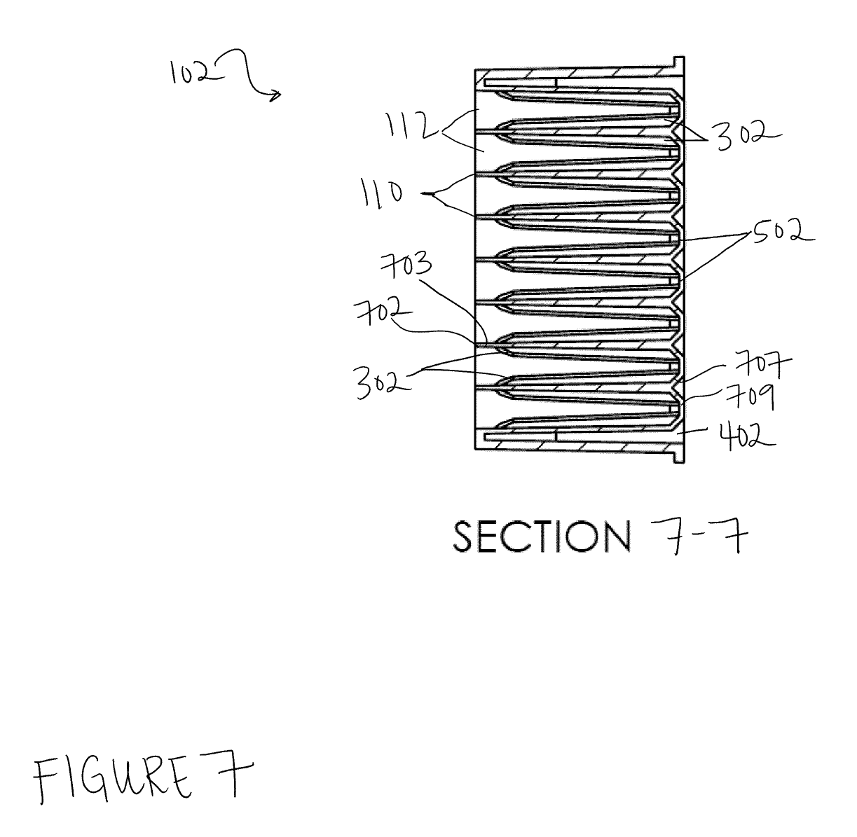

The number of and orientation of posts, e.g., 210, of adapter 202 mates with the number and orientation of opposed, mating post cavities vertically penetrating the underside (not shown in FIG. 2) of well plate 102. Referring to FIG. 5, the post cavities, e.g., 402, in the well plate 102 can be disposed at the intersection of the well walls, e.g., 110, intermediate adjacent wells, e.g., 112. Thus, the posts 112 may be offset by a pre-determined amount from the center of each well 112 so that when the well plate 102 is lowered onto the adapter, the posts 210 are complementary to the cavities on the underside of the well plate 102. In the well plate embodiment of FIG. 6, the bottom, e.g., 502 of each well, e.g., 112, in the well plate 102 is rounded (providing a semi-circular cross-section spanning the diameter width of the well, e.g., 112, not shown in FIG. 6). Post cavities, e.g., 402, are disposed at the intersections of adjacent well side walls, e.g., 110, that form and separate wells, e.g., 112. Thus, the interior periphery of cavities, e.g., 402, are configured to mate with the exterior periphery of mating adapter posts (not shown in FIG. 6. With reference now to FIG. 7, each well, e.g., 112, has tapered fins, e.g., 302, extending from an upper section, e.g., 703, of the well, e.g., 112, extending inwardly within the well, e.g., 112, from the well sidewall corner, e.g., 705, and downwardly, terminating at the junction, e.g., 707, of the fin, e.g., 302, with the bottom 709 of the well, e.g., 112. In the embodiment of FIG. 7, the bottom of each well, e.g., 112, has a frusto-conical or inverted-partial-pyramidal cross-section, which can, in some embodiments, provide a narrowed lowermost bottom end, e.g., 711, for extraction of, for example, liquid (not shown) from the bottom, e.g., 709, of the well, e.g., 112.

In some embodiments, each pair of adjacent fins, e.g., 302, (or other structure within the well) can create additional pockets of space between the fins, e.g., 302, within the wells 112. Thus, in one embodiment, items such as magnetic beads or pellets may be suspended in the liquid and pulled into the pockets of space created by adjacent fins 302 when a magnetic field is applied to the well plate 102. The collection of the items into the pockets created by the fins enables collection of liquid from the well without disturbing the items. Thus, the pockets of space can sequester the beads away from a pipette tip when collecting the liquid without disturbing the beads or pellets. Having spaces created by the fins provides the additional advantage of more efficient recovery of the beads or pellets, and enables the ability to use significantly less liquid to re-suspend the beads in solution when the magnetic field is removed.

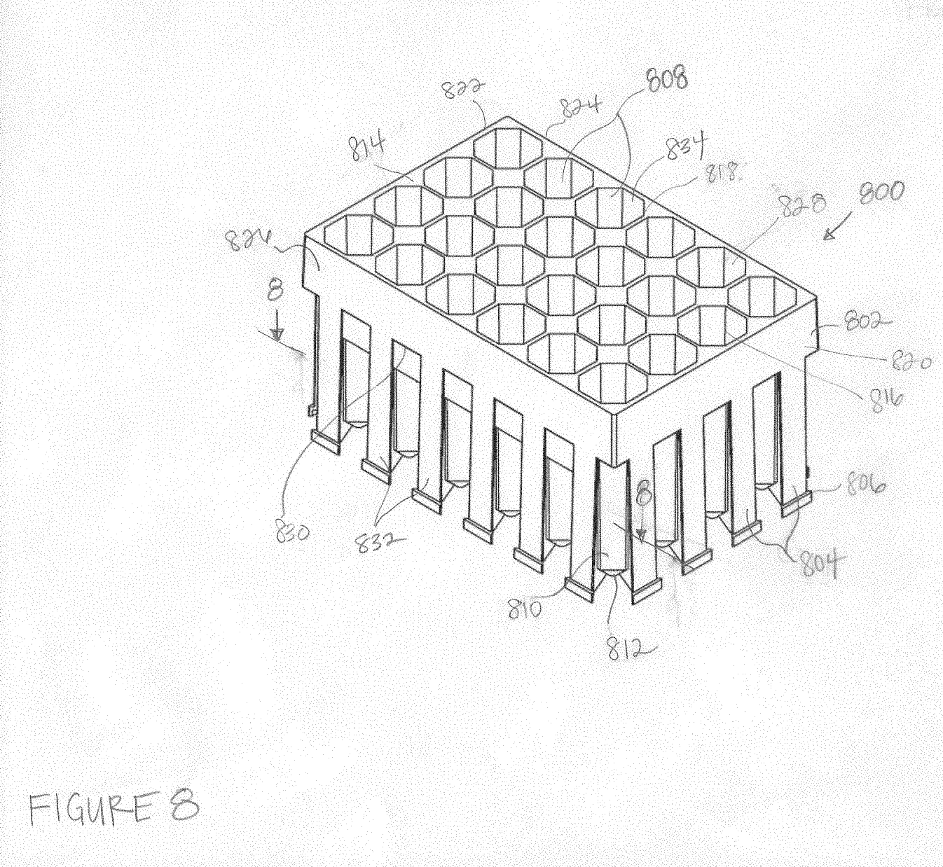

FIG. 8 shows an isometric view of another embodiment of an environmental control or processing well plate. In some embodiments, for example, well plate 800 is thermally conductive and may be an alternative example of a well plate 102 as described with reference to FIG. 1. In some embodiments, the well plate 800 may be consist of a single, unitary piece of plastic material, with the well plate 800 made by way of any suitable means such as, for example, by molding, extrusion or printing. In some embodiments, the components of well plate 800 may be formed separately (e.g., molded or extruded individually), and affixed together after formation. Affixation may be by any suitable technique, including such as previously described above.

In FIG. 8, an exemplary 24-well plate 800 is shown. Well plate 800 provides a rectangular configuration of four (4) rows, e.g, 816, by six (6) columns, e.g., 828, of wells, e.g., 808, separated by a plurality of common walls, e.g., 818, yielding a row-to-column ratio of 2:3. Well plate 800 has two opposed short planar sides 820, 822 extending perpendicularly between two opposed long planar sides 824, 826, cooperatively forming a rectangular housing 802 surrounding the wells, e.g., 808, within the housing 802. The housing 802 also has (i) a generally flat, rectangular top 814 co-planar with the upper edges of the wells, e.g., 808, opposite (ii) a slotted lower edge 832 extending outwardly from the bottom 830 of the housing 802. The slotted lower edge 802 may include a plurality of outwardly extending plate mounting arms, e.g., 804, with the distal end 803 of each arm, e.g., 804, having a mounting lip 806 extending perpendicularly from a mounting lip support 807 extending from the housing 802.

The upper edges, e.g., 814, of the wells, e.g., 808, cooperatively provide a flat rectangular grid, with the interior upper side edge, e.g., 815, of each well, e.g., 808, having, in this example, an octagonal shape. The shape of the wells, e.g., 808, may vary from the upper edge, e.g., 808, of the well, e.g., 808 down through the bottom of the well, e.g., 808, at the bottom, e.g., 812 of the well plate 802. Each octagonal well, e.g., 808, has a longitudinally extending inner walls, e.g., 834, creating interior well volume, e.g., 840, which terminates in the well bottom, e.g., 812.

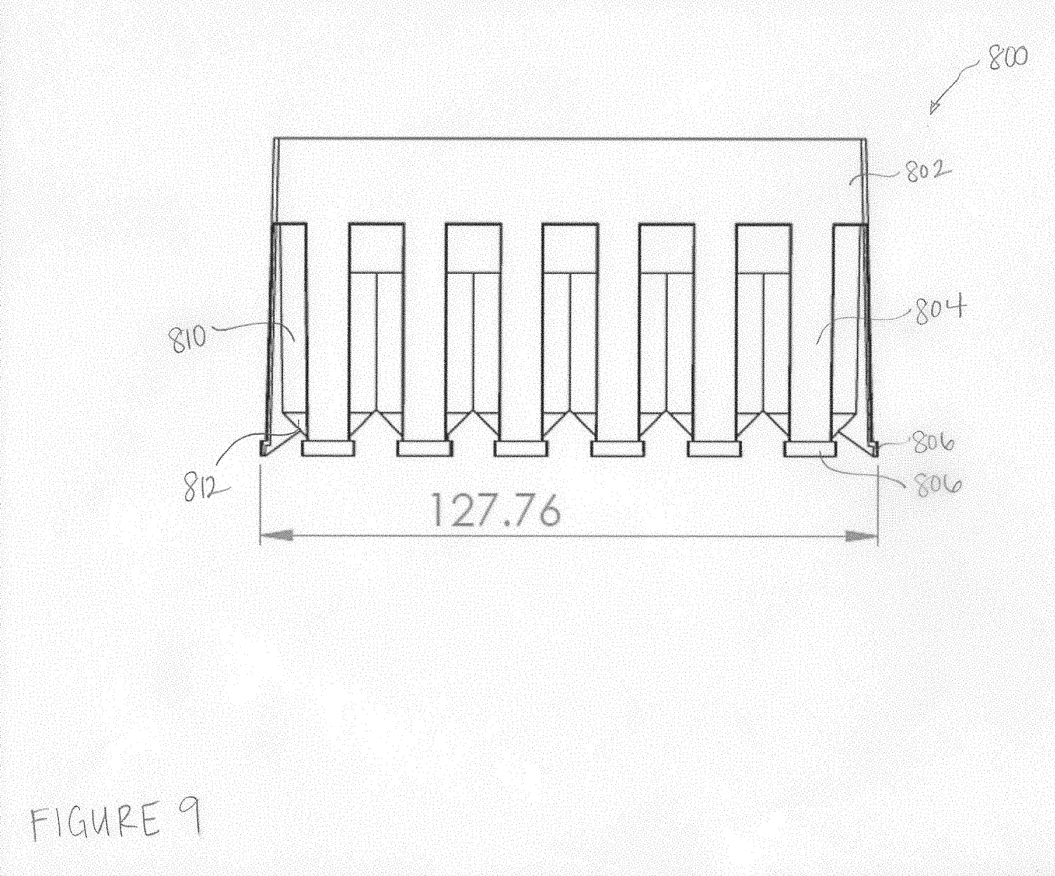

Turning now to FIG. 9, the interior volume, e.g., 840 (id.), of wells, e.g., 808, may terminate in a well bottom 812 where liquid, and potentially other materials, may be stored, processed, and/or utilized. In the FIG. 9 embodiment, the bottom, e.g., 812, of wells e.g., 808, is shaped in an inverse pyramidal shape, with angular sloping sides connecting at a square or pointed distal end at the lowermost end of the well bottom, e.g., 812.

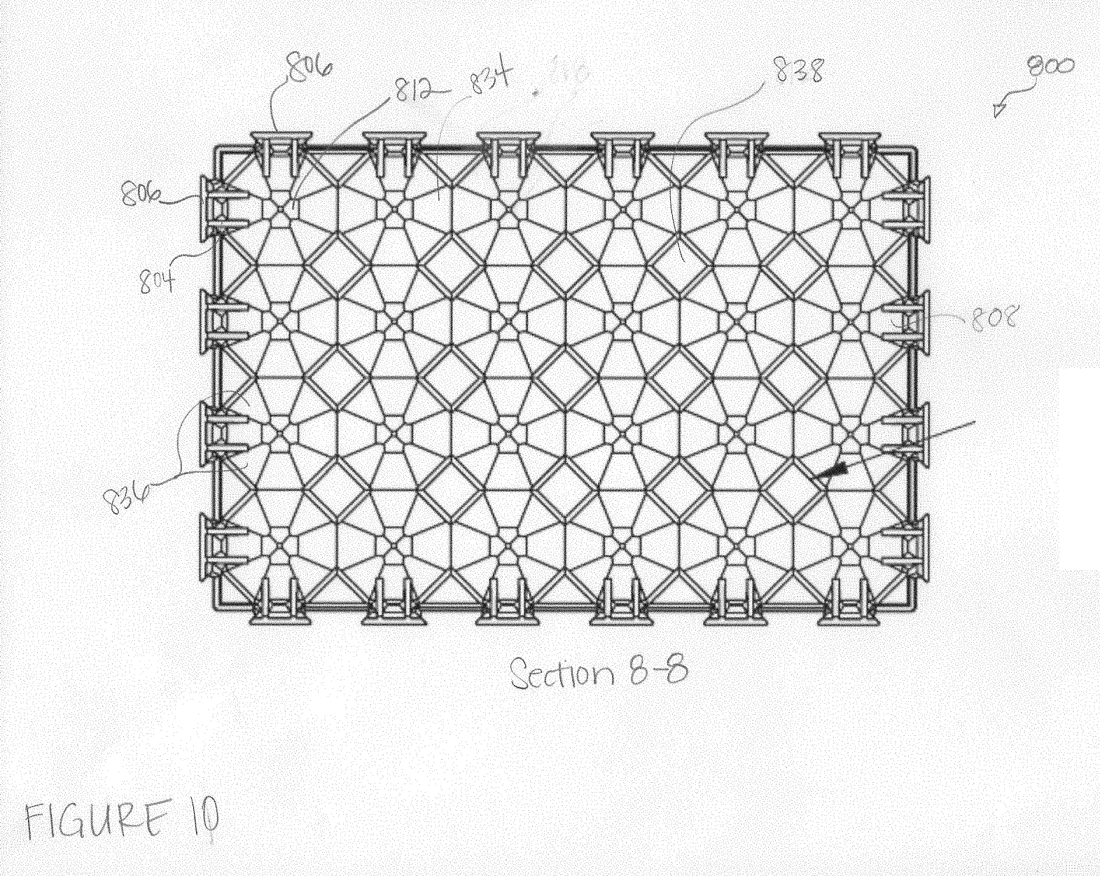

With reference now to FIGS. 9 and 10, the generally octagonal wells, e.g, 808, are separated within rectangular housing 802 by common well side walls, e.g., 818. Extending inwardly from the downwardly extending inner well walls, e.g., 834 of each well, e.g., 808, are a plurality of inwardly protruding baffles, protrusions, or fins, e.g., 836. In the embodiment of FIG. 10, a plurality of fins, e.g., 836, extend inwardly within the well, e.g., 808, from every other downwardly extending inner well wall, e.g., 835, 837, within the each well, e.g., 808. In other embodiments, the fins may extend inwardly from any of the well walls and do not necessarily need to provide a well wall with no fin intermediate opposed well walls having a protruding fin.

The fins, e.g., 836, may be affixed to the inside of walls, e.g., 818, and extend inward toward the axial center of the well, e.g., 808. The fins, e.g., 836, may be formed, such as by molding, printing, or extrusion, as an integral part of the well, e.g., 808, well plate 800. As with the well plate 800 as a whole, the fins, e.g., 836, may be made of a plastic material or other material providing desired heat transfer or magnetic properties. The fins, e.g., 836, may be the same plastic or other material of the remainder of the well plate 803, or the fins, e.g., 836, may be made of a different plastic or other materials.

The fins, e.g., 836, are shown as being of equal length and symmetrically disposed within the well, e.g., 836; however, the fins, e.g., may be symmetric, asymmetric, and of varying length, widths, and/or shapes. Regardless of their number and placement, the fins 836, expand the surface area of the material (not shown) within the well, e.g., 808 while providing enough volume within in the well, e.g., 808, for insertion of, for example, a pipette tip into the well, e.g., 808, to add or remove material, such as a liquid for example (not shown) within the well, e.g., 808.

In some embodiments, one or more such fins (or other well varying structure, inwardly or outwardly from the general periphery of the well) within one or more, or all, of the wells in well plate can therefore increase the surface area of the interior well surface (and the well plate 800 as a whole) so that, via heat transfer through the fins and possibly other adjacent structure as well, the temperature of the liquid in the wells can be modulated and controlled more quickly and efficiently than wells not including one or more such structure(s). In this regard, however, the fins or other well surface expanding structures may also be provided to control other aspects of the well or materials in the well, such as magnetic aspects or other processing aspects that may be provided by materials incorporated into or on a fin or other such structures.

Post passages or cavities, e.g, 838, extend within the well plate 800 transversely upwardly from the bottom of the well plate housing 802. As described previously with reference to FIGS. 4A though 4D, adapter posts or other mating structure (not shown) may penetrate partially or fully within, and if desired abut, matingly configured post penetrating cavities, e.g., 838, extending vertically in or laterally through the well plate 800.

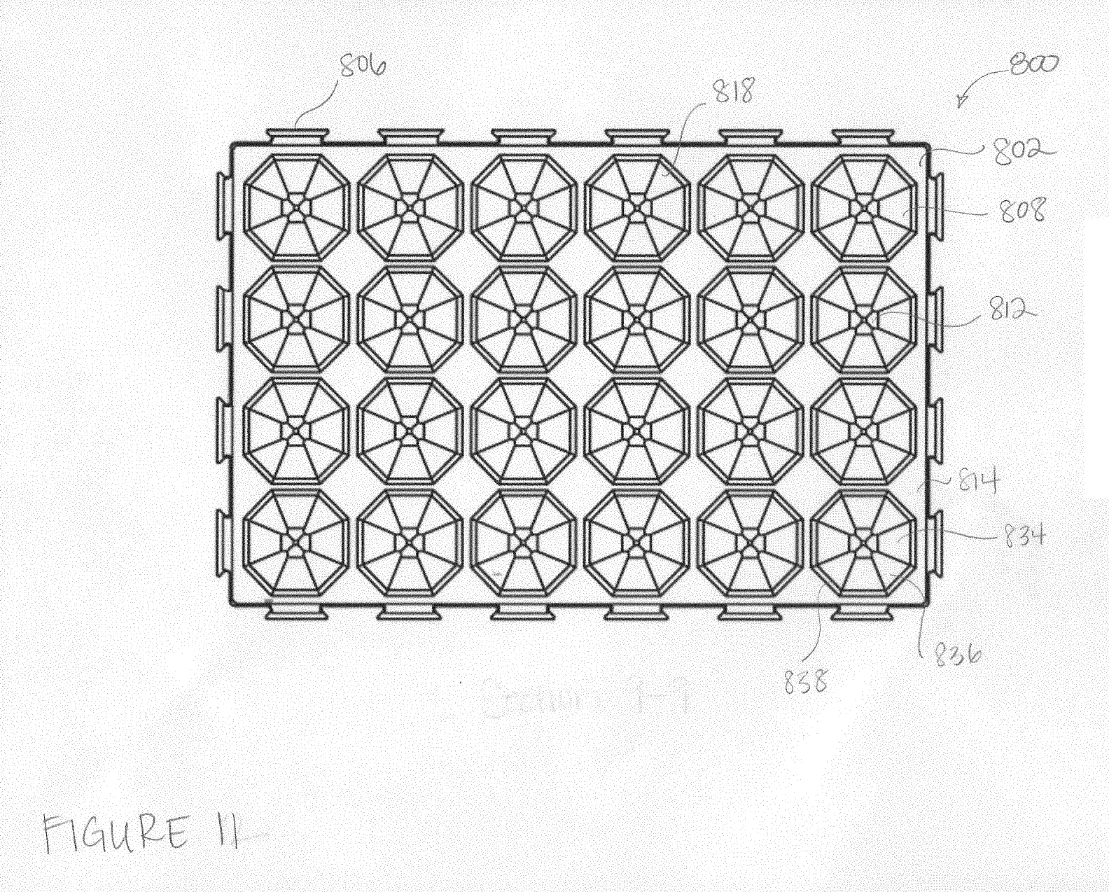

With reference now to FIG. 11, fins 836, just as described previously with respect to the fins of FIG. 7, may have an innermost side within the well, e.g., 808, tapered or sloped from the junction of the fin with an upper section of the well, e.g., 808 to widen the surface area of the fin adjacent the bottom of the well, e.g., 80812. In the embodiment of FIG. 11, the bottom of each well, e.g., 808, has a octagonal cross-section, which can, in some embodiments, provide a narrowed lowermost bottom end for extraction of, for example, liquid (not shown) from the bottom, e.g., 812, of wells, e.g., 808.

In FIG. 11, fins are shown as having a triangular or pyramidal cross-section. In other embodiments, the fins may be thin walls extending perpendicularly from each inner wall 834 towards the axial center of well 808. In this embodiment, there may be a fin for each wall, and thus, there may be eight fins in each well as opposed to the four shown in FIG. 11.

As described with reference to FIG. 7, in some embodiments, each pair of adjacent fins, e.g., 836, (or other structure within the well) can create additional pockets of space between the fins, e.g., 836, within the wells, e.g., 808. Thus, in one embodiment, items such as magnetic beads or pellets may be suspended in the liquid and pulled into the pockets of space created by adjacent fins, e.g., 836, when a magnetic field is applied to the well plate 800. The collection of the items into the pockets created by the fins enables collection of liquid from the well without disturbing the items. Thus, the pockets of space can sequester the beads away from a pipette tip when collecting the liquid without disturbing the beads or pellets. Having spaces created by the fins provides the additional advantage of more efficient recovery of the beads or pellets, and enables the ability to use significantly less liquid to re-suspend the beads in solution when the magnetic field is removed.

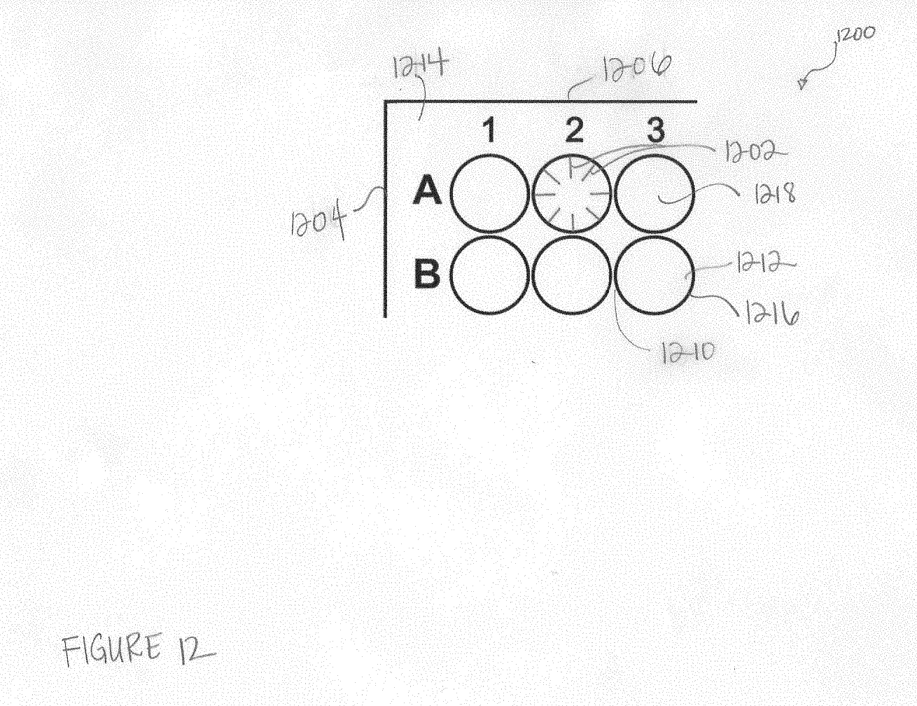

FIG. 12 show a top plan view of another embodiment of a well plate. In particular, FIG. 12 may show only a portion (i.e., the upper left section) of a well plate 1200 where the portion of well plate 1200 has two rows and three columns of example wells 1212. Well plate 1200 may be a different embodiment of well plates 102 and 800 described with reference to FIGS. 1-11. In FIG. 12, well plate 1202 has two opposed short planar sides 1204 extending perpendicularly between two opposed long planar sides 1206, cooperatively forming a rectangular housing 1214 surrounding the wells 1212. The wells 1212 may be formed and separated from each other by common walls 1210. The walls 1210 may provide a circular cross-section at the upper-edge of each well 1212 and the walls 1210 may taper inward or may flare outward as the walls extend towards the bottom of the housing 1214 (not shown in FIG. 12)

Extending inwardly from the inside periphery the well walls of each well 1212 are a plurality of inwardly protruding baffles, protrusions, or fins 1202. In the embodiment of FIG. 12, eight fins extending radially and inwardly within the well 1212 along the inner circumference 1216 of the well. In FIG. 2, the fins may be straight walls extending inwards towards the axial center of each well 1212 such that the thin edge of each straight wall attaches to the inner wall of each well 121.

The fins 1202 may be formed, such as by molding, printing, or extrusion, as an integral part of the well 1212, and well plate 1200. The fins, e.g., 1202, are shown as being of equal length and symmetrically disposed within the well, e.g., 1212; however, the fins, e.g., may be symmetric, asymmetric, of varying length, widths, and/or shapes. Regardless of their number and placement, the fins 1202, expand the surface area of the material (not shown) within the well, e.g., 1212 while providing enough space in the well, e.g., 1212, such as its central area, e.g., 1218, for insertion of, for example, a pipette tip into the well, e.g., 1212, to add or remove material, such as a liquid for example (not shown) within the well, e.g., 1212.

On reading this specification, those of skill in the art will recognize that many of the components discussed as separate units may be combined into one unit and an individual unit may be split into several different units. Further, the various functions could be contained in one computer or spread over several networked computers and/or devices. The identified components may be upgraded and replaced as associated technology improves, advances are made in computing technology, or based on a developers skills or preferences.

The process parameters, functions, system features, and sequence of steps described and/or illustrated herein are given by way of example only and may be varied and mixed and matched as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The foregoing detailed description has described some specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems, their components, and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.” Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Finally, any ranges stated above include all sub-ranges within the range.

What we claim is:

1. An ANSI-SLAS compatible environmental control reservoir apparatus comprising:
a ANSI-SLAS compatible well plate having:
a housing; and
a plurality of wells extending within the housing, each of the wells having one or more side walls and environmental control means for extending from the side of a well into the interior of the well.

2. The ANSI-SLAS compatible environmental control reservoir apparatus of claim 1 wherein the environmental control means comprises a fin.

3. The ANSI-SLAS compatible environmental control reservoir apparatus of claim 1 also comprising an adapter providing means for controlling an environmental aspect of the environmental control means.

4. The ANSI-SLAS compatible environmental control reservoir apparatus of claim 2 also comprising an adapter providing means for controlling an environmental aspect of the environmental control means.

5. The ANSI-SLAS compatible environmental control reservoir apparatus of claim 4 wherein the means for controlling includes a plurality of posts penetrable within mating passages adjacent associated wells in the well plate.
